(19) United States
(12) Patent Application Publication
(10) Pub. No.: US 2016/0130432 A1
(43) Pub. Date: May 12, 2016

(54) COMPOSITION FOR FIBER-REINFORCED COMPOSITE MATERIAL, PREPREG, AND FIBER-REINFORCED COMPOSITE MATERIAL

(71) Applicant: DAICEL CORPORATION, Osaka-shi, Osaka (JP)

(72) Inventors: Ken SUMII, Himeji-shi (JP); Toshifumi FUKUI, Himeji-shi (JP); Katsuya MARUO, Himeji-shi (JP)

(73) Assignee: DAICEL CORPORATION, Osaka-shi, Osaka (JP)

(21) Appl. No.: 14/893,337

(22) PCT Filed: May 20, 2014
(86) PCT No.: PCT/JP2014/063295

§ 371 Date: Nov. 23, 2015

(30) Foreign Application Priority Data
May 24, 2013 (JP) 2013-110362

(51) Int. Cl. C08L 63/04; C08L 33/08; C08L 63/00

(52) U.S. Cl. CPC C08L 63/04; C08L 63/00; C08L 33/08

(57) ABSTRACT

There is provided a composition for a fiber-reinforced composite material, the composition being capable of forming the fiber-reinforced composite material having a long pot life, the excellent work stability, and a high heat resistance. The composition for a fiber-reinforced composite material according to the present invention contains a radically polymerizable compound (A) having not less than two radically polymerizable groups in one molecule thereof, a cationically polymerizable compound (B) having not less than two cationically polymerizable groups in one molecule thereof, a radical polymerization initiator (C) having a 10-hour half-life decomposition temperature of not less than 85° C.; and an acid generator (D) having an exothermic onset temperature of not less than 100° C. as measured using a differential scanning calorimeter (DSC) at a temperature-rise rate of 10° C./min, wherein the composition has a viscosity at 25° C. of not less than 10,000 mPa·s.

### TECHNICAL FIELD

The present invention relates to a composition for a fiber-reinforced composite material, a prepreg, and a fiber-reinforced composite material. The present invention relates particularly to a composition for forming a composite material (composite material of fibers with a resin) reinforced with the fibers (reinforcing fibers) such as carbon fibers and glass fibers, a prepreg, and the composite material (fiber-reinforced composite material). The present application claims priority to Japanese Patent Application No. 2013-110362, filed on May 24, 2013, the entire contents of which are hereby incorporated by reference.

### BACKGROUND ART

Fiber-reinforced composite materials are composite materials composed of reinforcing fibers with a resin (matrix resin), and are broadly utilized in the fields of automobile parts, civil engineering and construction supplies, blades for wind power generators, sports goods, aircrafts, marine vessels, robots, cable materials and the like. As reinforcing fibers in the fiber-reinforced composite materials, there are used, for example, glass fibers, aramid fibers, carbon fibers and boron fibers. Further as matrix resins in the fiber-reinforced composite materials, there are often used thermosetting resins easily impregnated into reinforcing fibers. As such thermosetting reins, there are used, for example, epoxy resins, unsaturated polyester resins, vinyl ester resins, phenol resins, maleimide resins and cyanate resins.

As materials for forming fiber-reinforced composite materials, there are known, for example, a thermosetting resin composition containing a glycidylamine-type epoxy resin and a bisphenol F-type epoxy resin, and a curable resin composition containing an acid anhydride curing agent (see Patent Literature 1). Additionally, there are known, for example, a thermosetting resin composition containing an alicyclic epoxy resin and a monoallyl diglycidyl isocyanurate compound, and a prepreg, for a fiber-reinforced composite material, containing a curing agent and containing a flame-resistant reinforcing fiber (see Patent Literature 2).

### CITATION LIST

### Patent Literature

Patent Literature 1: Japanese Patent Laid-Open No. 2013-001767
Patent Literature 2: Japanese Patent Laid-Open No. 2013-023554

### SUMMARY OF INVENTION

### Technical Problem

As curing agents of epoxy resins, there have been used amines such as imidazole derivatives, and acid anhydrides such as methyl himic anhydride. These curing agents, however, are responsive within a broad temperature range and thus gradually progress the reaction even at room temperature; so the pot life is short. Then, the curing agent must be added right before its use, and thus it poses the problem of being inferior in the work stability.

Hence, it is the present situation that there are still obtained no compositions (compositions for fiber-reinforced composite materials) which, as materials for forming fiber-reinforced composite materials, have a sufficient pot life and therefore an excellent work stability, and can quickly progress the curing reaction when being cured. Although particularly in recent years, along with the expansion of applications of fiber-reinforced composite materials, the high heat resistance (for example, a heat resistance capable of withstanding use under an environment of as high a temperature as 200° C.) comes to be demanded, there can be still obtained no compositions which can form fiber-reinforced composite materials having such a high heat resistance, are excellent in the work stability, and exhibit a high curing speed.

Therefore, an object of the present invention is to provide a composition for a fiber-reinforced composite material which can form the fiber-reinforced composite material having a long pot life, the excellent work stability, and a high heat resistance.

Further, another object of the present invention is to provide a prepreg which is formed by impregnating the above composition for a fiber-reinforced composite material into a reinforcing fiber, and can form the fiber-reinforced composite material having a high heat resistance.

Yet another object of the present invention is to provide a fiber-reinforced composite material having a high heat resistance.

### Solution to Problem

As a result of diligent studies to solve the above objects, the present inventors have found that a composition containing a specific radically polymerizable compound, a specific cationically polymerizable compound, a specific radical polymerization initiator, and a specific acid generator can form a fiber-reinforced composite material having a long pot life, the excellent work stability, and a high heat resistance; and this finding has led to the completion of the present invention.

That is, the present invention provides a composition for a fiber-reinforced composite material, which composition contains a radically polymerizable compound (A) having not less than two radically polymerizable groups in one molecule thereof, a cationically polymerizable compound (B) having not less than two cationically polymerizable groups in one molecule thereof, a radical polymerization initiator (C) having a 10-hour half-life decomposition temperature of not less than 85° C., and an acid generator (D) having an exothermic onset temperature of not less than 100° C. as measured using a differential scanning calorimeter (DSC) at a temperature-rise rate of 10° C./min, and has a viscosity at 25° C. of not less than 10,000 mPa·s.

The cationically polymerizable compound (B) may be at least one compound selected from the group consisting of epoxy compounds, oxetane compounds and vinyl ether compounds.

The proportion (weight ratio) [(A)/(B)] of the radically polymerizable compound (A) to the cationically polymerizable compound (B) is preferably more than 0/100 and not more than 80/20.

The content of the radical polymerization initiator (C) is, for example, 0.01 to 10 parts by weight based on 100 parts by weight of the total amount of the radically polymerizable compound (A) and the cationically polymerizable compound (B).

The content of the acid generator (D) is, for example, 0.1 to 20 parts by weight based on 100 parts by weight of the total amount of the radically polymerizable compound (A) and the cationically polymerizable compound (B).

The radically polymerizable compound (A) is preferably a compound having a cyclic structure. Further the radically polymerizable compound (A) is preferably a compound having a tricyclodecane skeleton.

The cationically polymerizable compound (B) is preferably a compound having a cyclic structure. Further the cationically polymerizable compound (B) is preferably a compound having a tricyclodecane skeleton.

The composition for a fiber-reinforced composite material preferably has a pot life (a time until the viscosity becomes two times the initial viscosity) at 25° C. of not less than 14 days.

The present invention further provides a prepreg which is formed by impregnating the composition for a fiber-reinforced composite material into a reinforcing fiber (E).

The prepreg preferably has a fiber mass content rate (Wf) of the reinforcing fiber (E) of 50 to 90% by weight.

The reinforcing fiber (E) may be at least one selected from the group consisting of carbon fibers, glass fibers and aramid fibers.

The present invention further provides a fiber-reinforced composite material which is obtained by curing the prepreg.

That is, the present invention relates to the following.

(1) A composition for a fiber-reinforced composite material, which composition contains a radically polymerizable compound (A) having not less than two radically polymerizable groups in one molecule thereof, a cationically polymerizable compound (B) having not less than two cationically polymerizable groups in one molecule thereof, a radical polymerization initiator (C) having a 10-hour half-life decomposition temperature of not less than 85° C., and an acid generator (D) having an exothermic onset temperature of not less than 100° C. as measured using a differential scanning calorimeter (DSC) at a temperature-rise rate of 10° C./min, and has a viscosity at 25° C. of not less than 10,000 mPa·s.

(2) The composition for a fiber-reinforced composite material according to (1), wherein the cationically polymerizable compound (B) is at least one compound selected from the group consisting of epoxy compounds, oxetane compounds and vinyl ether compounds.

(3) The composition for a fiber-reinforced composite material according to (1) or (2), wherein the proportion (weight ratio) [(A)/(B)] of the radically polymerizable compound (A) to the cationically polymerizable compound (B) is more than 0/100 and not more than 80/20.

(4) The composition for a fiber-reinforced composite material according to any one of (1) to (3), wherein the content of the radically polymerizable compound (A) is 10 to 75% by weight based on the total amount (100% by weight) of the composition.

(5) The composition for a fiber-reinforced composite material according to any one of (1) to (4), wherein the content of the cationically polymerizable compound (B) is 10 to 75% by weight based on the total amount (100% by weight) of the composition.

(6) The composition for a fiber-reinforced composite material according to any one of (1) to (5), wherein the content of the radical polymerization initiator (C) is 0.01 to 10 parts by weight based on 100 parts by weight of the total amount of the radically polymerizable compound (A) and the cationically polymerizable compound (B).

(7) The composition for a fiber-reinforced composite material according to any one of (1) to (6), wherein the content of the acid generator (D) is 0.1 to 20 parts by weight based on 100 parts by weight of the total amount of the radically polymerizable compound (A) and the cationically polymerizable compound (B).

(8) The composition for a fiber-reinforced composite material according to any one of (1) to (7), wherein the radically polymerizable compound (A) is at least one selected from the group consisting of a radically polymerizable compound (A-1) having two radically polymerizable groups in one molecule thereof and having a cyclic structure in its molecule, and a radically polymerizable compound (A-2) having not less than three radically polymerizable groups in one molecule thereof.

(9) The composition for a fiber-reinforced composite material according to (8), wherein the proportion of the radically polymerizable compound (A-1) to the whole of the radically polymerizable compound (A) is not less than 30% by weight.

(10) The composition for a fiber-reinforced composite material according to any one of (1) to (9), wherein the radically polymerizable compound (A) is a compound having a cyclic structure.

(11) The composition for a fiber-reinforced composite material according to any one of (1) to (10), wherein the radically polymerizable compound (A) is a compound having a tricyclodecane skeleton.

(12) The composition for a fiber-reinforced composite material according to any one of (1) to (11), wherein the radically polymerizable compound (A) is at least one selected from the group consisting of dimethyloldicyclopentane di(meth)acrylate and tricyclodecanediol di(meth)acrylate.

(13) The composition for a fiber-reinforced composite material according to any one of (1) to (12), wherein the functional group equivalent weight of the radically polymerizable group of the radically polymerizable compound (A) is 50 to 300.

(14) The composition for a fiber-reinforced composite material according to any one of (1) to (13), wherein the cationically polymerizable compound (B) is a compound having a cyclic structure.

(15) The composition for a fiber-reinforced composite material according to any one of (1) to (14), wherein the cationically polymerizable compound (B) is at least one selected from the group consisting of bisphenol-type epoxy resins, cresol novolac-type epoxy resins, phenol novolac-type epoxy resins, resorcinol-type epoxy resins, phenol alkyl-type epoxy resins, dicyclopentadiene-type epoxy resins (epoxy resins having a tricyclodecane skeleton), epoxy compounds having a biphenyl skeleton, epoxy compounds having a naphthalene skeleton, and epoxy compounds having a fluorene skeleton.

(16) The composition for a fiber-reinforced composite material according to any one of (1) to (15), wherein the cationically polymerizable compound (B) is a compound having a tricyclodecane skeleton.

(17) The composition for a fiber-reinforced composite material according to any one of (1) to (16), wherein the functional group equivalent weight of the cationically polymerizable group of the cationically polymerizable compound (B) is 50 to 400.

(18) The composition for a fiber-reinforced composite material according to any one of (1) to (17), wherein the radical polymerization initiator (C) is at least one selected from the group consisting of 1,1-bis(t-butylperoxy)cyclohexane, 2,2-bis(4,4-di-t-butylperoxycyclohexyl)propane, 2,2-bis(t-butylperoxy) butane, n-butyl 4,4-bis(t-butylperoxy)valerate, 2,5-dimethyl-2,5-bis(t-butylperoxy)hexyne-3, di-t-butyl peroxide, t-butyl cumyl peroxide, 2,5-dimethyl-2,5-bis(t-butylperoxy)hexane, dicumyl peroxide, α,α′-bis(t-butylperoxy)diisopropylbenzene, t-butyl hydroperoxide, p-menthane hydroperoxide, diisopropylbenzene hydroperoxide, 1,1,3,3-tetramethylbutyl hydroperoxide, cumene hydroperoxide, t-hexyl peroxyisopropylmonocarbonate, t-butylperoxymaleic acid, t-butyl peroxy-3,5,5-trimethylhexanoate, t-butyl peroxylaurate, t-butyl peroxyisopropylmonocarbonate, t-butyl peroxy-2-ethylhexylmonocarbonate, t-hexyl peroxybenzoate, 2,5-dimethyl-2,5-bis(benzoylperoxy)hexane, t-butyl peroxyacetate, t-butyl peroxy-m-toluoylbenzoate, t-butyl peroxybenzoate, 2-(carbamoylazo)isobutyronitrile, 2-phenylazo-4-methoxy-2,4-dimethylvaleronitrile, 2,2′-azobis(2,4,4-trimethylpentane), 2,2′-azobis(2-methyl-N-2-propenylpropanamide), and 2,2′-azobis(N-butyl-2-methylpropionamide).

(19) The composition for a fiber-reinforced composite material according to any one of (1) to (18), wherein the acid generator (D) is at least one selected from the group consisting of triarylsulfonium hexafluorophosphate, triarylsulfonium hexafluoroantimonates, diaryliodonium hexafluorophosphates, diphenyliodonium hexafluoroantimonate, bis(dodecylphenyl)iodonium tetrakis(pentafluorophenyl)borate and iodonium[4-(4-methylphenyl-2-methylpropyl)phenyl]hexafluorophosphate.

(20) The composition for a fiber-reinforced composite material according to any one of (1) to (19), wherein the pot life (a time until the viscosity becomes two times the initial viscosity) at 25° C. is not less than 14 days.

(21) A prepreg, being formed by impregnating a composition for a fiber-reinforced composite material according to any one of (1) to (20) into a reinforcing fiber (E).

(22) The prepreg according to (21), wherein the fiber mass content rate (Wf) of the reinforcing fiber (E) is 50 to 90% by weight.

(23) The prepreg according to (21) or (22), wherein the reinforcing fiber (E) is at least one selected from the group consisting of carbon fibers, glass fibers, aramid fibers, boron fibers, graphite fibers, silicon carbide fibers, high-strength polyethylene fibers, tungsten carbide fibers and polyparaphenylene benzoxazole fibers (PBO fibers).

(24) The prepreg according to any one of (21) to (23), wherein the reinforcing fiber (E) is at least one selected from the group consisting of carbon fibers, glass fibers and aramid fibers.

(25) A fiber-reinforced composite material, being obtained by curing a prepreg according to any one of (21) to (24).

### Advantageous Effects of Invention

The composition for a fiber-reinforced composite material according to the present invention has a long pot life and the excellent work stability, since having the above constitution. Moreover, the composition can form a fiber-reinforced composite material having a high heat resistance by curing. Hence, the fiber-reinforced composite material obtained by curing the composition for a fiber-reinforced composite material or the prepreg according to the present invention is excellent in production stability and high in heat resistance.

### DESCRIPTION OF EMBODIMENTS

<Composition for a Fiber-Reinforced Composite Material>

The composition for a fiber-reinforced composite material according to the present invention (referred to simply as “composition according to the present invention” in some cases) contains a radically polymerizable compound (A) having not less than two radically polymerizable groups in one molecule thereof, a cationically polymerizable compound (B) having not less than two cationically polymerizable groups in one molecule thereof, a radical polymerization initiator (C) having a 10-hour half-life decomposition temperature of not less than 85° C., and an acid generator (D) having an exothermic onset temperature of not less than 100° C. as measured using a differential scanning calorimeter (DSC) at a temperature-rise rate of 10° C./min, and has a viscosity at 25° C. of not less than 10,000 mPa·s.

### [Radically Polymerizable Compound (A)]

The radically polymerizable compound (A) in the composition according to the present invention is a compound having not less than two radically polymerizable groups in one molecule thereof.

The radically polymerizable group of the radically polymerizable compound (A) is not especially limited as long as being a functional group capable of causing a radical polymerization reaction, but examples thereof include groups containing a carbon-carbon unsaturated double bond, and specific examples thereof include a vinyl group, a (meth)allyl group, and a (meth)acryloyl group. Here, not less than two radically polymerizable groups of the radically polymerizable compound (A) may be identical or different from each other.

The number of the radically polymerizable groups in one molecule of the radically polymerizable compound (A) is not especially limited as long as being not less than two, but 2 or 20 groups is preferable; 2 to 15 groups is more preferable; and 2 to 10 groups is still more preferable.

Specific examples of the radically polymerizable compound (A) include vinyl compounds such as divinylbenzene; and (meth)acrylates such as ethylene glycol di(meth)acrylate, triethylene glycol di(meth)acrylate, 1,3-butanediol di(meth)acrylate, 1,4-butanediol di(meth)acrylate, tetramethylene glycol di(meth)acrylate, propylene glycol di(meth)acrylate, neopentyl glycol di(meth)acrylate, tetraethylene glycol di(meth)acrylate, bisphenol A epoxy di(meth)acrylate, 9,9-bis[(4-(2-(meth)acryloyloxyethoxy)phenyl)]fluorene, nonanediol di(meth)acrylate, diethylene glycol di(meth)acrylate, polyethylene glycol di(meth)acrylate, polypropylene glycol di(meth)acrylate, polytetramethylene glycol di(meth)acrylate, pentaerythritol di(meth)acrylate, dipentaerythritol di(meth)acrylate, dimethyloldicyclopentane di(meth)acrylate (=tricyclodecanedimethanol di(meth)acrylate), tricyclodecanediol di(meth)acrylate, alkylene oxide-modified bisphenol A (meth)acrylates (for example, ethoxylated (ethylene oxide-modified)bisphenol A di(meth)acrylates), trimethylolpropane tri(meth)acrylate, trimethylolethane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, 2,2,2-tris(meth)acryloyloxymethyl ethyl succinate, alkylene oxide-modified isocyanuric acid tri(meth)acrylates (for example, ethoxylated (ethylene oxide-modified) isocyanuric acid tri(meth)acrylates, and urethane (meth)acrylates.

Among these, as the radically polymerizable compound (A), preferable are a radically polymerizable compound (A-1) having two radically polymerizable groups in one molecule thereof and a cyclic structure [a monocyclic or polycyclic aromatic ring such as a benzene ring or a naphthalene ring; a monocyclic alicyclic skeleton such as a cyclohexane ring; a polycyclic alicyclic skeleton such as a tricyclodecane ring; a monocyclic or polycyclic heteroring; and the like](particularly a polycyclic structure) in its molecule, and a radically polymerizable compound (A-2) having not less than three radically polymerizable groups in one molecule thereof. The compound (A-1) specifically includes radically polymerizable compounds such as divinylbenzene, bisphenol A epoxy di(meth)acrylate, 9,9-bis[(4-(2-(meth)acryloyloxyethoxy)phenyl)]fluorene, dimethyloldicyclopentane di(meth)acrylate (=tricyclodecanedimethanol di(meth)acrylate), tricyclodecanediol di(meth)acrylate and alkylene oxide-modified bisphenol A di(meth)acrylates (for example, ethoxylated bisphenol A di(meth)acrylates). Further the compounds (A-2) specifically include trimethylolpropane tri(meth)acrylate, trimethylolethane tri(meth)acrylate, pentaerythritol tri(meth)acrylate, pentaerythritol tetra(meth)acrylate, dipentaerythritol tri(meth)acrylate, dipentaerythritol tetra(meth)acrylate, dipentaerythritol penta(meth)acrylate, dipentaerythritol hexa(meth)acrylate, 2,2,2-tris(meth)acryloyloxymethyl ethyl succinate, alkylene oxide-modified isocyanuric acid tri(meth)acrylates (for example, ethoxylated isocyanuric acid tri(meth)acrylates), and urethane (meth)acrylates having not less than three (meth)acryloyl groups in one molecule thereof. Use of a combination of a radically polymerizable compound (A-1) and a radically polymerizable compound (A-2) is also preferable.

Particularly, from the viewpoint of enabling the pot life of the composition to be long, and the heat resistance and the elastic modulus of a cured material and a fiber-reinforced composite material, preferable as the radically polymerizable compound (A) is a radically polymerizable compound (A-1) having two radically polymerizable groups in one molecule thereof and a cyclic structure (an aromatic ring, a monocyclic or polycyclic aliphatic ring, a monocyclic or polycyclic heteroring or the like) in its molecule. Particularly, preferable as the radically polymerizable compound (A) is a radically polymerizable compound (A-11) having two radically polymerizable groups in one molecule thereof and having a polycyclic alicyclic skeleton (particularly a tricyclodecane skeleton) in its molecule [for example, dimethyloldicyclopentane di(meth)acrylate (=tricyclodecanedimethanol di(meth)acrylate), tricyclodecanediol di(meth)acrylate or the like]. The proportion of the radically polymerizable compound (A-1)[or (A-11)] to the whole of the radically polymerizable compound (A) is preferably not less than 30% by weight, more preferably not less than 50% by weight, and especially preferably not less than 70% by weight.

The functional group equivalent weight of the radically polymerizable group of the radically polymerizable compound (A) is, for example, 50 to 300, preferably 70 to 280, and more preferably 80 to 260. When the functional group equivalent weight is less than 50, the mechanical strength of a cured material and a fiber-reinforced composite material becomes liable to decrease. By contrast, when the functional group equivalent weight is more than 300, the heat resistance and the mechanical properties of the cured material and the fiber-reinforced composite material become liable to decrease. Here, the functional group equivalent weight of the radically polymerizable group of the radically polymerizable compound (A) can be calculated from the following expression.

[A functional group equivalent weight of a radically polymerizable group]=[a molecular weight of a radically polymerizable compound (A)]/[the number of the radically polymerizable group of the radically polymerizable compound (A)]

Here, in the composition according to the present invention, the radically polymerizable compound (A) can be used singly or can be used in a combination of not less than two thereof. Further as the radically polymerizable compound (A), there can also be used commercially available products, for example, “IRR214-K” by trade name (dimethyloldicyclopentane diacrylate (=tricyclodecanedimethanol diacrylate), manufactured by Daicel-Cytec Co., Ltd.), “A-BPE-4” by trade name (ethoxylated bisphenol A diacrylate, manufactured by Shin-Nakamura Chemical Co., Ltd.), “A-9300” by trade name (ethoxylated isocyanuric acid triacrylate, manufactured by Shin-Nakamura Chemical Co., Ltd.), “A-TMM-3” by trade name (pentaerythritol triacrylate, manufactured by Shin-Nakamura Chemical Co., Ltd.), “DPHA” by trade name (dipentaerythritol hexaacrylate, manufactured by Daicel-Cytec Co., Ltd.), KRM8452 (aliphatic urethane acrylate, manufactured by Daicel-Cytec Co., Ltd.), and “EBECRYL 130” by trade name (diacrylate having a tricyclodecane skeleton, manufactured by Daicel-Cytec Co., Ltd.).

The content (blend amount) of the radically polymerizable compound (A) in the composition according to the present invention is not especially limited, but is, based on the total amount (100% by weight) of the composition, preferably 10 to 75% by weight, more preferably 30 to 65% by weight, and still more preferably 35 to 60% by weight. When the content is less than 10% by weight, the curing speed decreases and the heat resistance of a cured material decreases in some cases. By contrast, when the content is more than 75% by weight, the interfacial strength of a cured material and fibers decreases in some cases. Here, in the case of concurrently using not less than two radically polymerizable compounds (A), it is preferable that the total amount of the radically polymerizable compounds (A) be controlled in the above range.

Here, the composition according to the present invention may contain a radically polymerizable compound other than the radically polymerizable compound (A). The radically polymerizable compound other than the radically polymerizable compound (A) includes compounds having one radically polymerizable group in one molecule thereof. Examples of the compounds having one radically polymerizable group in one molecule thereof include vinyl compounds such as styrene, 2-chlorostyrene, 2-bromostyrene, methoxystyrene, 1-vinylnaphthalene and 2-vinylnaphthalene; and (meth)acrylates such as 2-phenoxyethyl (meth)acrylate, benzyl (meth)acrylate, o-phenylphenol (meth)acrylate, nonylphenoxypolyethylene glycol (meth)acrylate, tetrahydrofurfuryl (meth)acrylate, triethylene glycol mono(meth)acrylate, 1,3-butanediol mono(meth)acrylate, tetramethylene glycol mono(meth)acrylate, propylene glycol mono(meth)acrylate (for example, 1,2-propanediol-1-(meth)acrylate), neopentyl glycol mono(meth)acrylate, methoxypolyethylene glycol (meth)acrylate, dicyclopentenyl (meth)acrylate, dicyclopentenyloxyethyl (meth)acrylate, dicyclopentanyl (meth)acrylate, pentamethylpiperidinyl (meth)acrylate, tetramethylpiperidinyl (meth)acrylate, and tetrahydrofurfuryl (meth)acrylate.

### [Cationically Polymerizable Compound (B)]

The cationically polymerizable compound (B) in the composition according to the present invention is a compound having not less than two cationically polymerizable groups in one molecule thereof.

The cationically polymerizable group of the cationically polymerizable compound (B) is not especially limited as long as being a functional group capable of causing a cationic polymerization reaction, but examples thereof include an epoxy group, an oxetanyl group and a vinyl ether group. Here, the cationically polymerizable compound (B) has not less than two cationically polymerizable groups, but these cationically polymerizable groups may be identical or different from each other.

The number of the cationically polymerizable groups in one molecule of the cationically polymerizable compound (B) is not especially limited as long as being not less than two, but is preferably 2 to 20, more preferably 2 to 15, and especially preferably 2 to 10.

Examples of the cationically polymerizable compound (B) include epoxy compounds (compounds having not less than two epoxy groups in one molecule thereof, and the like), oxetane compounds (compounds having not less than two oxetanyl groups in one molecule thereof, and the like), and vinyl ether compounds (compounds having not less than two vinyl ether groups in one molecule thereof, and the like).

Specific examples of the epoxy compound include bisphenol-type epoxy resins such as bisphenol A-type epoxy resins (bisphenol A diglycidyl ether and the like), bisphenol F-type epoxy resins (bisphenol F diglycidyl ether and the like), bisphenol S-type epoxy resins (bisphenol S diglycidyl ether and the like), halogen-substitution products thereof (for example, brominated epoxy resins such as brominated bisphenol A diglycidyl ether, brominated bisphenol F diglycidyl ether and brominated bisphenol S diglycidyl ether), alkyl-substitution products or hydrogenation products thereof (for example, hydrogenated bisphenol A diglycidyl ether, hydrogenated bisphenol F diglycidyl ether and hydrogenated bisphenol S diglycidyl ether); and cresol novolac-type epoxy resins, phenol novolac-type epoxy resins, resorcinol-type epoxy resins, phenol alkyl-type epoxy resins, dicyclopentadiene-type epoxy resins (epoxy resins having a tricyclodecane skeleton, for example, phenol-dicyclopentadiene-type epoxy resins and alkylphenol-dicyclopentadiene-type epoxy resins), epoxy compounds having a biphenyl skeleton (for example, biphenol diglycidyl ether and tetramethylbiphenol diglycidyl ether), epoxy compounds having a naphthalene skeleton (for example, naphthalenediol diglycidyl ether), epoxy compounds having a fluorene skeleton (for example, bisphenolfluorene diglycidyl ether, biscresolfluorene diglycidyl ether and bisphenoxyethanolfluorene diglycidyl ether).

Specific examples of the oxetane compound include 3,3-bis(chloromethyl)oxetane, 1,4-bis[(3-ethyl-3-oxetanylmethoxy)methyl]benzene, bis{[1-ethyl(3-oxetanyl)]]methyl}ether, 4,4′-bis[(3-ethyl-3-oxetanyl)methoxymethyl]bicyclohexyl, 1,4-bis[(3-ethyl-3-oxetanyl)methoxymethyl)]cyclohexane, 1,4-bis{[((3-ethyl-3-oxetanyl)methoxy]methyl}benzene, 3-ethyl-3-{[(3-ethyloxetan-3-yl)methoxy]methyl}oxetane, xylylene bisoxetane, 3-ethyl-3-{[3-(triethoxysilyl)propoxy]methyl}oxetane, oxetanylsilsesquioxane, and phenol novolac oxetanes.

Specific examples of the vinyl ether compound include 3,3-bis(vinyloxymethyl)oxetane, 1,6-hexanediol divinyl ether, 1,4-cyclohexanedimethanol divinyl ether, 1,3-cyclohexanedimethanol divinyl ether, 1,2-cyclohexanedimethanol divinyl ether, p-xylene glycol divinyl ether, m-xylene glycol divinyl ether, o-xylene glycol divinyl ether, diethylene glycol divinyl ether, triethylene glycol divinyl ether, tetraethylene glycol divinyl ether, pentaethylene glycol divinyl ether, oligoethylene glycol divinyl ether, polyethylene glycol divinyl ether, dipropylene glycol divinyl ether, tripropylene glycol divinyl ether, tetrapropylene glycol divinyl ether, pentapropylene glycol divinyl ether, oligopropylene glycol divinyl ether, polypropylene glycol divinyl ether, isosorbide divinyl ether, oxanorbornene divinyl ether, hydroquinone divinyl ether, 1,4-butanediol divinyl ether, and cyclohexanedimethanol divinyl ether.

Among these, the cationically polymerizable compound (B) is, from the viewpoint of enabling the pot life of the composition to be long, and the curing speed and the heat resistance of a cured material and a fiber-reinforced composite material, preferably a compound having not less than one cyclic structure in one molecule thereof. Examples of such compounds include bisphenol-type epoxy resins, cresol novolac-type epoxy resins, phenol novolac-type epoxy resins, resorcinol-type epoxy resins, phenol alkyl-type epoxy resins, dicyclopentadiene-type epoxy resins (epoxy resins having a tricyclodecane skeleton), epoxy compounds having a biphenyl skeleton, epoxy compounds having a naphthalene skeleton, and epoxy compounds having a fluorene skeleton. Particularly the cationically polymerizable compound (B) is preferably a compound having a tricyclodecane skeleton such as a dicyclopentadiene-type epoxy resin.

Here, commercially available products of the bisphenol-type epoxy resin include “YD-128” by trade name (bisphenol A-type epoxy resin, manufactured by Nippon Steel & Sumikin Chemical Co., Ltd.), and “YD-170” (bisphenol F-type epoxy resin, manufactured by Nippon Steel & Sumikin Chemical Co., Ltd.). Commercially available products of the cresol novolac-type epoxy resin include “N-655-EXP-S”, “N-662-EXP-S”, “N-665-EXP-S”, “N-670-EXP-S” and “N-685-EXP-S” by trade names (the foregoing, manufactured by DIC Corp.). Commercially available products of the phenol novolac-type epoxy resin include “N-740”, “N-770” and “N-775” by trade names (the foregoing, manufactured by DIC Corp.). Commercially available products of the resorcinol-type epoxy resin include “EX-201” by trade name (manufactured by Nagase ChemteX Corp.). Commercially available products of the dicyclopentadiene-type epoxy resin include “HP-7200”, “HP-7200L” and “HP-7200H” by trade names (the foregoing, manufactured by DIC Corp.). Commercially available products of the biphenyl-type epoxy resin include “YX-4000” and “YX-4000H” by trade names (the foregoing, manufactured by Mitsubishi Chemical Corp.). Commercially available products of the oxetane compound include “OXT-221” by trade name (manufactured by Toagosei Co., Ltd.), and “OXT-121” by trade name (manufactured by Toagosei Co., Ltd.).

The functional group equivalent weight of the cationically polymerizable group of the cationically polymerizable compound (B) is not especially limited, but is preferably 50 to 400, more preferably 80 to 350, and still more preferably 100 to 300. When the functional group equivalent weight is less than 50, the toughness of a cured material and a fiber-reinforced composite material becomes insufficient in some cases. By contrast, when the functional group equivalent weight is more than 400, the heat resistance and the mechanical properties of the cured material and the fiber-reinforced composite material decrease in some cases. Here, the functional group equivalent weight of the cationically polymerizable group of the cationically polymerizable compound (B) can be calculated from the following expression.

[A functional group equivalent weight of a cationically polymerizable group]=[a molecular weight of a cationically polymerizable compound (B)]/[the number of the cationically polymerizable group of the cationically polymerizable compound (B)]

Here, in the composition according to the present invention, the cationically polymerizable compound (B) can be used singly or can be used in a combination of not less than two thereof.

The content (blend amount) of the cationically polymerizable compound (B) in the composition according to the present invention is not especially limited, but is, based on the total amount (100% by weight) of the composition, preferably 10 to 75% by weight, more preferably 30 to 65% by weight, and still more preferably 35 to 60% by weight. When the content is less than 10% by weight, the interfacial strength of a cured material and fibers decreases and the heat resistance of a cured material decreases in some cases. By contrast, when the content is more than 75% by weight, the curing speed of the composition decreases and the heat resistance of the cured material decreases in some cases. Here, in the case of concurrently using not less than two cationically polymerizable compounds (B), it is preferable that the total amount of the cationically polymerizable compounds (B) be controlled in the above range.

Here, the composition according to the present invention may contain a cationically polymerizable compound other than the cationically polymerizable compound (B). The cationically polymerizable compound other than the cationically polymerizable compound (B) includes compounds having one cationically polymerizable group in one molecule thereof. The compounds having one cationically polymerizable group in one molecule thereof include epoxy compounds having one epoxy group in one molecule thereof, oxetane compounds having one oxetane group in one molecule thereof, and vinyl ether compounds having one vinyl ether group in one molecule thereof.

Examples of the epoxy compounds include cyclohexene oxide, 3,4-epoxycyclohexylmethyl alcohol, 3,4-epoxycyclohexylethyltrimethoxysilane, dioctyl epoxyhexahydrophthalate, di-2-ethylhexyl epoxyhexahydrophthalate, monoglycidyl ethers of aliphatic higher alcohols; monoglycidyl ethers of polyether alcohols, which are obtained by adding alkylene oxides to phenol, cresol, butylphenol or these; and glycidyl esters of higher fatty acids.

Examples of the oxetane compounds include 3-ethyl-3-hydroxymethyloxetane, 3-ethyl-3-(2-ethylhexyloxymethyl)oxetane, 3-ethyl-3-(hydroxymethyl)oxetane, 3-ethyl-3-[(phenoxy)methyl]oxetane, 3-ethyl-3-(hexyloxymethyl)oxetane, and 3-ethyl-3-(chloromethyl)oxetane.

Examples of the vinyl ether compounds include 2-hydroxyethyl vinyl ether, 3-hydroxypropyl vinyl ether, 2-hydroxypropyl vinyl ether, 2-hydroxyisopropyl vinyl ether, 4-hydroxybutyl vinyl ether, 3-hydroxyisobutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol monovinyl ether, 1,4-cyclohexanedimethanol monovinyl ether, 1,3-cyclohexanedimethanol monovinyl ether, 1,2-cyclohexanedimethanol monovinyl ether, p-xylene glycol monovinyl ether, m-xylene glycol monovinyl ether, o-xylene glycol monovinyl ether, diethylene glycol monovinyl ether, triethylene glycol monovinyl ether, tetraethylene glycol monovinyl ether, pentaethylene glycol monovinyl ether, oligoethylene glycol monovinyl ether, polyethylene glycol monovinyl ether, dipropylene glycol monovinyl ether, tripropylene glycol monovinyl ether, tetrapropylene glycol monovinyl ether, pentapropylene glycol monovinyl ether, oligopropylene glycol monovinyl ether, polypropylene glycol monovinyl ether, phenyl vinyl ether, n-butyl vinyl ether, octyl vinyl ether, and cyclohexyl vinyl ether.

The proportion (weight ratio) [radically polymerizable compound (A)/cationically polymerizable compound (B)] of the radically polymerizable compound (A) to the cationically polymerizable compound (B) in the composition according to the present invention is not especially limited, but is preferably more than 0/100 and not more than 80/20, more preferably 10/90 to 70/30, and still more preferably 30/70 to 60/40. When the proportion of the radically polymerizable compound (A) [a proportion thereof to the total amount (100% by weight) of the radically polymerizable compound (A) and the cationically polymerizable compound (B)] is 0% by weight, the curing speed decreases. By contrast, when the proportion of the radically polymerizable compound (A) is more than 80% by weight, the mechanical strength of a cured material and a fiber-reinforced composite material or the interfacial strength of the cured material and fibers decreases in some cases.

### [Radical Polymerization Initiator (C)]

The radical polymerization initiator (C) in the composition according to the present invention is a radical polymerization initiator having a 10-hour half-life decomposition temperature (a temperature at which an amount of active oxygen becomes half an original amount thereof in 10 hours) of not less than 85° C. The 10-hour half-life decomposition temperature of the radical polymerization initiator (C) is preferably not less than 88° C., and more preferably not less than 90° C. The radical polymerization initiator (C) functions to initiate a polymerization reaction (radical polymerization reaction) of a compound (the radically polymerizable compound (A)) having a radically polymerizable group among curable compounds in the composition. If a radical polymerization initiator having a 10-hour half-life decomposition temperature of less than 85° C. is used, the pot life of the composition decreases, which is not preferable. The radical polymerization initiator (C) is not especially limited as long as being a radical polymerization initiator having a 10-hour half-life decomposition temperature of not less than 85° C., and for example, a thermal radical polymerization initiator or the like can be used. In the radical polymerization initiator (C), the upper limit of the 10-hour half-life decomposition temperature is, for example, 180° C., more preferably 150° C., and especially preferably 110° C.

Examples of the thermal radical polymerization initiator include organic peroxides. As the organic peroxides, there can be used, for example, dialkyl peroxides, acyl peroxides, hydroperoxides, ketone peroxides and peroxyesters. Specific examples of the organic peroxides having a 10-hour half-life decomposition temperature of not less than 85° C. include 1,1-bis(t-butylperoxy)cyclohexane, 2,2-bis(4,4-di-t-butylperoxycyclohexyl)propane, 2,2-bis(t-butylperoxy) butane, n-butyl 4,4-bis(t-butylperoxy)valerate, 2,5-dimethyl-2,5-bis(t-butylperoxy)hexyne-3, di-t-butyl peroxide, t-butyl cumyl peroxide, 2,5-dimethyl-2,5-bis(t-butylperoxy)hexane, dicumyl peroxide, α,α′-bis(t-butylperoxy)diisopropylbenzene, t-butyl hydroperoxide, p-menthane hydroperoxide, diisopropylbenzene hydroperoxide, 1,1,3,3-tetramethylbutyl hydroperoxide, cumene hydroperoxide, t-hexyl peroxyisopropylmonocarbonate, t-butylperoxymaleic acid, t-butyl peroxy-3,5,5-trimethylhexanoate, t-butyl peroxylaurate, t-butyl peroxyisopropylmonocarbonate, t-butyl peroxy-2-ethylhexylmonocarbonate, t-hexyl peroxybenzoate, 2,5-dimethyl-2,5-bis(benzoylperoxy)hexane, t-butyl peroxyacetate, t-butyl peroxy-m-toluoylbenzoate, and t-butyl peroxybenzoate. Further, as commercially available products thereof, there can be used “Perhexa C(S)”, “Perhexyl D”, “Permenta H” and “Perhexyl I” by trade names (the foregoing, manufactured by NOF Corp.).

As the thermal radical polymerization initiators, other than the organic peroxides, azo compounds can be used. Examples of the azo compounds having a 10-hour half-life decomposition temperature of not less than 85° C. include 2-(carbamoylazo)isobutyronitrile, 2-phenylazo-4-methoxy-2,4-dimethylvaleronitrile, 2,2′-azobis(2,4,4-trimethylpentane), 2,2′-azobis(2-methyl-N-2-propenylpropanamide), and 2,2′-azobis(N-butyl-2-methylpropionamide). As the thermal radical polymerization initiators, there can also be used or concurrently used inorganic peroxides such as persulfate salts (for example, potassium persulfate and ammonium persulfate).

Here, in the composition according to the present invention, the radical polymerization initiator (C) can be used singly or in a combination of not less than two thereof.

The content (blend amount) of the radical polymerization initiator (C) in the composition according to the present invention is not especially limited, but is, based on 100 parts by weight of the total amount of the radically polymerizable compound (A) and the cationically polymerizable compound (B), preferably 0.01 to 10 parts by weight, more preferably 0.05 to 8 parts by weight, and still more preferably 0.1 to 5 parts by weight. When the content is less than 0.01 part by weight, the progress of the curing speed becomes insufficient in some cases. By contrast, when the content is more than 10 parts by weight, the heat resistance of a cured material and a fiber-reinforced composite material, though depending on applications, becomes insufficient in some cases. Here, in the case where not less than two radical polymerization initiators (C) are concurrently used, it is preferable that the total amount of the radical polymerization initiators (C) be controlled in the above range.

### [Acid Generator (D)]

The acid generator (D) in the composition according to the present invention is an acid generator having an exothermic onset temperature of not less than 100° C. (preferably not less than 110° C., more preferably not less than 120° C.) as measured using a differential scanning calorimeter (DSC) at a temperature-rise rate of 10° C./min. The acid generator (D) functions to initiate a polymerization reaction (cationic polymerization reaction) of a compound (the cationically polymerizable compound (B)) having a cationically polymerizable group among curable compounds in the composition. If an acid generator having the exothermic onset temperature of less than 100° C. is used, the pot life of the composition becomes short, which is not preferable. The acid generator (D) is not especially limited as long as having an exothermic onset temperature of not less than 100° C. as measured using a differential scanning calorimeter (DSC) at a temperature-rise rate of 10° C./min, but includes, for example, thermal acid generators. Here, in the acid generator (D), the upper limit of the exothermic onset temperature is, for example, 200° C., more preferably 150° C., and especially preferably 130° C.

The acid generator (D) includes compounds to generate an acid by heating or irradiation of active energy rays, and specific examples thereof include sulfonium salts such as triarylsulfonium hexafluorophosphate and triarylsulfonium hexafluoroantimonate; iodonium salts such as diaryliodonium hexafluorophosphate, diphenyliodonium hexafluoroantimonate, bis(dodecylphenyl)iodonium tetrakis(pentafluorophenyl)borate and iodonium[4-(4-methylphenyl-2-methylpropyl)phenyl]hexafluorophosphate; phosphonium salts such as tetrafluorophosphonium hexafluorophosphate; pyridinium salts; diazonium salts; selenium salts; and ammonium salts.

Examples of commercially available products of the acid generator (D) include “Sanaid SI-100L” by trade name, “Sanaid SI-100L” by trade name, “Sanaid SI-110” by trade name, “Sanaid SI-110L” by trade name, “Sanaid SI-145” by trade name, “Sanaid SI-150” by trade name, “Sanaid SI-160” by trade name, “Sanaid SI-180” by trade name and “Sanaid SI-180L” by trade name (the foregoing, manufactured by Sanshin Chemical Industry Co., Ltd.).

Here, in the composition according to the present invention, the acid generator (D) can be used singly or in a combination of not less than two thereof.

The content (blend amount) of the acid generator (D) in the composition according to the present invention is not especially limited, but is, based on 100 parts by weight of the total amount of the radically polymerizable compound (A) and the cationically polymerizable compound (B), preferably 0.1 to 20 parts by weight, more preferably 0.2 to 15 parts by weight, and still more preferably 0.3 to 5 parts by weight. When the content is less than 0.1 part by weight, the progress of the curing reaction becomes insufficient in some cases. By contrast, when the content is more than 20 parts by weight, the heat resistance of a cured material and a fiber-reinforced composite material, though depending on applications, becomes insufficient in some cases. Here, in the case where not less than two acid generators (D) are concurrently used, it is preferable that the total amount of the acid generators (D) be controlled in the above range.

To the composition according to the present invention, as required, other additives may further be added as long as not impairing the advantage of the present invention. Examples of the other additives include curable expandable monomers, photosensitizers (anthracene sensitizers and the like), resins, adhesion improvers, reinforcing agents, softening agents, plasticizers, viscosity regulators, solvents, inorganic or organic particles (nano-scale particles and the like), and various types of known common additives of fluorosilane and the like.

The composition according to the present invention can be produced by blending and homogeneously mixing the above-mentioned constituting components (the radically polymerizable compound (A), the cationically polymerizable compound (B), the radical polymerization initiator (C), the acid generator (D), the additives, and the like) in predetermined proportions. The mixing of the constituting components can be carried out by using a known or common stirring apparatus (mixing apparatus), and is not especially limited, and it can be carried out, for example, by using a stirring apparatus such as a rotation-revolution type stirring and defoaming apparatus, a homogenizer, a planetary mixer, a three-roll mill or a bead mill.

The viscosity at 25° C. of the composition according to the present invention suffices if being not less than 10,000 mPa·s. The viscosity at 25° C. of the composition according to the present invention is, from the viewpoint of the handleability and the workability, preferably 10,000 to 50,000 mPa·s, more preferably 10,000 to 45,000 mPa·s, and still more preferably 11,000 to 40,000 mPa·s. Here, the viscosity at 25° C. of the composition can be measured, for example, by a viscometer (trade name: “TV-22H”, manufactured by Toki Sangyou Co., Ltd.)(for example, rotor: 1°34′×R24, rotation frequency: 1.0 rpm, measurement temperature: 25° C.)

It is preferable that particularly from the viewpoint of the work stability, the composition according to the present invention have viscosities in the above range for both a viscosity (25° C.) right after the preparation (a viscosity measured within 1 hour of the preparation, referred to as “initial viscosity” in some cases) and a viscosity (25° C.) after the composition is left at 25° C. for 14 days after the preparation. Further it is preferable that the pot life (a time at which the viscosity becomes two times the initial viscosity) at 25° C. be not less than 14 days. It is preferable that particularly the viscosity (25° C.) after the composition is left at 25° C. for 14 days after the preparation be not more than 1.5 times (particularly not more than 1.3 times) the initial viscosity. The viscosity right after the preparation is controlled in the above range, but, for example, in the case where the viscosity after the composition is left at 25° C. for 14 days exceeds two times the initial viscosity, there is a possibility that curing progresses during the storage, and the work stability remarkably decreases and the quality of a cured material (particularly a fiber-reinforced composite material) decreases in some cases.

By polymerizing (more specifically, radically polymerizing and cationically polymerizing) the radically polymerizable compound (A) and the cationically polymerizable compound (B) in the composition according to the present invention, the composition according to the present invention can be cured to obtain a cured material (cured resin material). Means of initiating the polymerization reaction can suitably be selected according to the kinds and the contents of the radical polymerization initiator (C) and the acid generator (D), and is not especially limited, and it includes, for example, heating, and irradiation of active energy rays (for example, ultraviolet rays, infrared rays, visible light rays, and electron beams). Particularly, it is preferable that the polymerization reaction use a thermal radical polymerization initiator as the radical polymerization initiator (C) and a thermal acid generator as the acid generator (D), and be initiated by heating.

The conditions for curing the composition according to the present invention can suitably be selected depending on the kinds and the contents of the radical polymerization initiator (C) and the acid generator (D), and is not especially limited; but for example, as the conditions for the case of curing by heating, the heating temperature of 60 to 280° C. and the heating time of 0.1 to 5 hours are preferable (more preferably 0.5 to 4 hours, still more preferably 1 to 3 hours). When the heating temperature is too low or when the heating time is too short, the curing becomes insufficient and the heat resistance and the mechanical properties of a cured material decreases in some cases. By contrast, when the heating temperature is too high or when the heating time is too long, the decomposition and the deterioration of the components in the composition are caused in some cases.

In the case of curing by heating, the temperature condition may be raised stepwise. A cured material may be obtained, for example, through a primary curing step (also in this step, the temperature may be raised stepwise) of heating at a temperature of 60 to 185° C. for 0.1 to 3 hours (preferably 0.5 to 2 hours), and thereafter, a secondary curing step of heating at a temperature of more than 185° C. and not more than 280° C. for 0.1 to 2 hours (preferably 0.2 to 1.5 hours).

The glass transition temperature (Tg) of a cured material obtained by curing the composition according to the present invention is not especially limited, but is preferably not less than 100° C. (for example, 100 to 300° C.), more preferably not less than 140° C. (for example, 140 to 300° C.), still more preferably not less than 150° C., and especially preferably not less than 180° C. When the glass transition temperature is less than 100° C., the heat resistance of a fiber-reinforced composite material, though depending on applications, becomes insufficient in some cases. Here, the glass transition temperature can be determined, for example, by a measurement according to JIS K7244-4, in more detail, as a peak top temperature of tan δ (loss tangent) measured in a dynamic viscoelasticity measurement (which is carried out under the conditions of, for example, the temperature-rise rate: 5° C./min, the measurement temperatures: 25 to 350° C., and deformation mode: tensile mode).

### [Prepreg, Fiber-Reinforced Composite Material]

By impregnating the composition according to the present invention into a reinforcing fiber (E), a prepreg (referred to as “prepreg according to the present invention” in some cases) is formed. That is, the prepreg according to the present invention contains the composition according to the present invention and the reinforcing fiber (E) as essential components.

The reinforcing fiber (E) is not especially limited, but examples thereof include carbon fibers, glass fibers, aramid fibers, boron fibers, graphite fibers, silicon carbide fibers, high-strength polyethylene fibers, tungsten carbide fibers and polyparaphenylene benzoxazole fibers (PBO fibers). Examples of the carbon fiber include polyacrylonitrile (PAN)-based carbon fibers, pitch-based carbon fibers and vapor grown carbon fibers. Among these, from the viewpoint of the mechanical properties, carbon fibers, glass fibers and aramid fibers are preferable. Here, in the prepreg according to the present invention, the reinforcing fiber (E) can be used singly or can be used in a combination of not less than two thereof.

The form of the reinforcing fiber (E) in the prepreg according to the present invention is not especially limited, and examples thereof include forms of filaments (long fibers), forms of tows, forms of unidirectional materials in which tows are unidirectionally arrayed, forms of woven cloths and forms of nonwoven fabrics. Examples of the woven cloths of the reinforcing fiber (E) include plain woven ones, twill woven ones, satin woven ones, and stitching sheets obtained by stitching, so as not to be loosened, sheets in which fiber bundles represented by non-crimp fabrics are unidirectionally aligned or sheets in which sheets are laminated with angles thereof being varied.

The content of the reinforcing fibers (E) (referred to as “fiber mass content rate (Wf)” in some cases) in the prepreg according to the present invention is not especially limited, but is preferably 50 to 90% by weight, more preferably 60 to 85% by weight, and still more preferably 65 to 80% by weight. When the content is less than 50% by weight, the mechanical strength and the heat resistance of the fiber-reinforced composite material, though depending on applications, become insufficient in some cases. By contrast, when the content is more than 90% by weight, the mechanical strength (for example, toughness) of the fiber-reinforced composite material, though depending on applications, become insufficient in some cases.

The prepreg according to the present invention may be one obtained by impregnating the composition according to the present invention into the reinforcing fiber (E), and thereafter subjecting the resultant to heating, active energy-ray irradiation, or the like to thereby cure a part of curable compounds in the composition (that is, semi-cure).

A method for impregnating the composition according to the present invention into the reinforcing fiber (E) is not especially limited, and the impregnation can be carried out by an impregnation method in known or common prepreg production methods.

By curing the prepreg according to the present invention, the fiber-reinforced composite material can be obtained. The fiber-reinforced composite material, since a cured material of the composition according to the present invention is reinforced with the reinforcing fiber (E), has very excellent mechanical strength and heat resistance. The condition for curing the prepreg according to the present invention is not especially limited, but for example, the same condition as the above condition for curing the composition according to the present invention can be employed.

Production methods of the prepreg and the fiber-reinforced composite material according to the present invention can employ, for example, a pultrusion method. Specifically, the fiber-reinforced composite material can be obtained as follows: the reinforcing fiber (E) is continuously passed through a resin bath (a resin bath filled with the composition according to the present invention) to thereby impregnate the composition according to the present invention into the reinforcing fiber (E); then, as required, the resultant is passed through a squeeze die to thereby form a prepreg (the prepreg according to the present invention); thereafter, for example, the resultant is cured while being passed through a heated mold and subjected to continuous pultrusion by a pulling machine, to be thereby obtain the fiber-reinforced composite material. The obtained fiber-reinforced composite material may further be subjected to a heat treatment (post-baking) using an oven or the like.

The prepreg and the fiber-reinforced composite material according to the present invention can be produced not only by a method limited to the above-mentioned molding method (pultrusion method) but also by a known or common method for producing prepregs and fiber-reinforced composite materials, for example, methods of hand lay-up, prepreg, RTM, pultrusion, filament winding, spray-up and the like.

The fiber-reinforced composite material according to the present invention can be used as a material for various types of constructions, and is not especially limited, but it can preferably be used, for example, as a material for constructions such as: fuselages, main wings, tail assemblies, mobile wings, fairings, cowls, doors and the like of aircrafts; motor cases, main wings and the like of spacecrafts; body structures of artificial satellites; automobile parts such as chassis of automobiles; body structures of railroad vehicles; body structures of bicycles; body structures of marine vessels; blades of wind power generators; pressure vessels; fishing rods; tennis rackets; golf shafts; robot arms; and cables (for example, core materials of cables).

The fiber-reinforced composite material according to the present invention can preferably be used, for example, as a core material of electric wire to be used as aerial wire. Since the composite material according to the present invention is high in strength, small in weight and low in linear expansion coefficient, use of electric wire having a core material formed from the fiber-reinforced composite material according to the present invention enables the reduction of the number of steel towers and the improvement of the transmission capacity to be achieved. Further, since having a high heat resistance, the fiber-reinforced composite material according to the present invention can preferably be used as a core material for electric wire (high-tension wire) of a high voltage, which is liable to generate heat. The core material can be formed by a known method, for example, a pultrusion method or a stranded wire molding method.

### EXAMPLES

Hereinafter, the present invention will be described in detail by way of Examples, but the present invention is not limited to these Examples.

### Examples 1 to 5, and Comparative Examples 1 and 2

### Productions of Compositions for Fiber-Reinforced Composite Materials and Cured Materials

Each component was blended according to blending compositions (unit: parts by weight) indicated in Table 1, and stirred and mixed by a rotation-revolution-type mixer to thereby obtain compositions for fiber-reinforced composite materials.

Further, compositions for fiber-reinforced composite materials were each interposed between glass plates, and subjected to a heat treatment under the condition described in Table 1 to thereby obtain cured materials.

### [Evaluations]

For the composition for the fiber-reinforced composite materials and the cured materials obtained in Examples and Comparative Examples, the following evaluations were carried out.

### (1) Viscosity

The viscosities (mPa·s) at 25° C. of the compositions for fiber-reinforced composite materials obtained in Examples and Comparative Examples were measured right after the preparations (within 1 hour of the preparation) of the compositions. The results are shown in the column of “Initial Viscosity of Composition” of Table 1.

Further, after the compositions for fiber-reinforced composite materials were stored under the environment of 25° C. for 14 days after the preparations thereof, the viscosities (mPa·s) were measured. The results are shown in the column of “Viscosity after Storage at 25° C. for 14 Days of Composition” of Table 1.

Here, the measurement apparatus and the measurement condition of the viscosity were as follows.

### <Measurement Apparatus and Measurement Condition>

Measurement apparatus: a viscometer (trade name: “TV-22H”, manufactured by Toki Sangyou Co., Ltd.)

Measurement temperature: 25° C.

Rotor: 1°34′×R24

Rotation frequency: 1.0 rpm

### (2) Glass Transition Temperature of the Cured Material

The cured materials (thickness: 0.5 mm) obtained in Examples and Comparative Examples were cut out into 4 mm in width and 3 cm in length, and were used as samples.

Dynamic viscoelasticity analyses (DMA) of the samples obtained in the above were carried out under the following condition.

### <Measurement Apparatus and Measurement Condition>

Measurement apparatus: a solid elasticity analyzer (“RSAIII”, manufactured by TA Instruments)

Atmosphere: nitrogen

Temperature range: 25 to 350° C.

Temperature-rise rate: 5° C./min

Deformation mode: tensile mode

A peak top temperature of tan δ (loss tangent) measured in the above dynamic viscoelasticity analysis was determined as a glass transition temperature (Tg) of the cured materials each. The results are shown in the column of “Tg” of Table 1.

### [Table 1]

TABLE 1

| | | | Example 1 | Example 2 | Example 3 | Example 4 |
|---|---|---|---|---|---|---|
| Composition | Radically | IRR214-K | 49.37 | 49.37 | 49.37 | 49.37 |
| for Fiber- | Polymerizable | EBECRYL 130 | | | | |
| Reinforced | Compound (A) | | | | | |
| Composite | Cationically | N-670-EXP-S | 49.37 | | 24.68 | 39.49 |
| Material | Polymerizable | HP-7200 | | 49.37 | 24.68 | |
| | Compound (B) | YD-128 | | | | 9.87 |
| | Radical | Perhexa C(S) | 0.28 | 0.28 | 0.28 | 0.28 |
| | Polymerization | Perbutyl O | | | | |
| | Initiator | | | | | |
| | Acid Generator | Sanaid SI-100L | 0.99 | 0.99 | 0.99 | 0.99 |
| | | Sanaid SI-60L | | | | |

| Initial Viscosity of Composition | | 34020 | 10140 | 18720 | 13640 |
|---|---|---|---|---|---|
| (mPa · s/25° C.) | | | | | |
| Viscosity After Storage at 25° C. for 14 Days | | 33970 | 10620 | 18410 | 13650 |
| of the Composition (mPa · s/25° C.) | | | | | |
| Cured | Curing Condition | 65° C. × 1 h | 65° C. × 1 h | 115° C. × 0.5 h | 65° C. × 1 h |
| Material | | 150° C. × 0.5 h | 150° C. × 0.5 h | 180° C. × 0.5 h | 150° C. × 0.5 h |
| | | 200° C. × 0.5 h | 200° C. × 0.5 h | 250° C. × 0.5 h | 200° C. × 0.5 h |
| | | total 2 h 30 min | total 2 h 30 min | total 1 h 57 min | total 2 h 30 min |
| | Tg (° C.) | 211 | 202 | 214 | 210 |

| | | | | Comparative | Comparative |
|---|---|---|---|---|---|
| | | | Example 5 | Example 1 | Example 2 |
| Composition | Radically | IRR214-K | | 49.37 | |
| for Fiber- | Polymerizable | EBECRYL 130 | 49.37 | | 49.37 |
| Reinforced | Compound (A) | | | | |
| Composite | Cationically | N-670-EXP-S | 24.68 | 24.68 | 24.68 |
| Material | Polymerizable | HP-7200 | 24.68 | 24.68 | 24.68 |
| | Compound (B) | YD-128 | | | |
| | Radical | Perhexa C(S) | 0.28 | | |
| | Polymerization | Perbutyl O | | 0.28 | 0.28 |
| | Initiator | | | | |
| | Acid Generator | Sanaid SI-100L | 0.99 | 0.99 | |
| | | Sanaid SI-60L | | | 0.99 |

| Initial Viscosity of Composition | | 20590 | 18690 | 20590 |
|---|---|---|---|---|
| (mPa · s/25° C.) | | | | |
| Viscosity After Storage at 25° C. for 14 Days | | 22440 | 58790 | 90120 |
| of the Composition (mPa · s/25° C.) | | | | |
| Cured | Curing Condition | 100° C. × 40 min | 150° C. × 1 h | 150° C. × 1 h |
| Material | | 250° C. × 1.0 h | 220° C. × 0.5 h | 220° C. × 0.5 h |
| | | total 2 h 10 min | total 1 h 44 min | total 1 h 44 min |
| | Tg (° C.) | 225 | 215 | 202 |

As shown in Table 1, in the compositions for fiber-reinforced composite materials according to the present invention, the viscosities after the storage at 25° C. for 14 days exhibited almost no change from the viscosities right after the preparations, and the work stability was excellent. By contrast, in the compositions of Comparative Examples, the viscosities after the storage at 25° C. for 14 days increased by even not less than three times as compared with the viscosities right after the preparations, and the work stability was inferior.

Further the cured materials obtained by curing the compositions for fiber-reinforced composite materials according to the present invention had high glass transition temperatures.

Here, components used in Examples and Comparative Examples were as follows.

### [Radically Polymerizable Compounds (A)]

IRR214-K: dimethyloldicyclopentane diacrylate (manufactured by Daicel-Cytec Co., Ltd., molecular weight: 304, the number of acryloyl groups in one molecule: two, functional group equivalent weight: 152)

EBECRYL 130: diacrylate having a tricyclodecane skeleton (manufactured by Daicel-Cytec Co.)

### [Cationically Polymerizable Compounds (B)]

N-670-EXP-S: orthocresol novolac-type epoxy resin (manufactured by DIC Corp., functional group equivalent weight: 200 to 210)

HP-7200: dicyclopentadiene-type epoxy resin (manufactured by DIC Corp., functional group equivalent weight: 250 to 280)

YD-128: bisphenol type epoxy resin (manufactured by Nippon Steel & Sumikin Chemical Co., Ltd., functional group equivalent weight: 184 to 194)

### [Radical Polymerization Initiators]

Perhexa C(S): 1,1-di(t-butylperoxy)cyclohexane (manufactured by NOF Corp., 10-hour half-life decomposition temperature: 90.7° C.) (corresponding to the above radical polymerization initiator (C))

Perbutyl O: tert-butyl 2-ethylperoxyhexanoate (manufactured by NOF Corp., 10-hour half-life decomposition temperature: 72.1° C.)

### [Acid Generators]

Sanaid SI-100L: an aromatic sulfonium salt (manufactured by Sanshin Chemical Industry Co., Ltd., exothermic onset temperature as measured using a differential scanning calorimeter (DSC) at a temperature-rise rate of 10° C./min: 124.1° C.)(corresponding to the above acid generator (D))

Sanaid SI-60L: an aromatic sulfonium salt (manufactured by Sanshin Chemical Industry Co., Ltd., exothermic onset temperature as measured using a differential scanning calorimeter (DSC) at a temperature-rise rate of 10° C./min: 97.6° C.)

### INDUSTRIAL APPLICABILITY

The composition for a fiber-reinforced composite material according to the present invention, since having the above constitution, has a long pot life and is excellent in the work stability. Hence, the fiber-reinforced composite material obtained by curing the composition for a fiber-reinforced composite material or the prepreg according to the present invention is excellent in the production stability and has a high heat resistance.

1. A composition for a fiber-reinforced composite material, comprising: a radically polymerizable compound (A) having not less than two radically polymerizable groups in one molecule thereof; a cationically polymerizable compound (B) having not less than two cationically polymerizable groups in one molecule thereof; a radical polymerization initiator (C) having a 10-hour half-life decomposition temperature of not less than 85° C.; and an acid generator (D) having an exothermic onset temperature of not less than 100° C. as measured using a differential scanning calorimeter (DSC) at a temperature-rise rate of 10° C./min, wherein the composition has a viscosity at 25° C. of not less than 10,000 mPa·s.

2. The composition for a fiber-reinforced composite material according to claim 1, wherein the cationically polymerizable compound (B) is at least one compound selected from the group consisting of epoxy compounds, oxetane compounds and vinyl ether compounds.

3. The composition for a fiber-reinforced composite material according to claim 1, wherein a proportion (weight ratio) [(A)/(B)] of the radically polymerizable compound (A) to the cationically polymerizable compound (B) is more than 0/100 and not more than 80/20.

4. The composition for a fiber-reinforced composite material according to claim 1, wherein the content of the radical polymerization initiator (C) is 0.01 to 10 parts by weight based on 100 parts by weight of the total amount of the radically polymerizable compound (A) and the cationically polymerizable compound (B).

5. The composition for a fiber-reinforced composite material according to claim 1, wherein the content of the acid generator (D) is 0.1 to 20 parts by weight based on 100 parts by weight of the total amount of the radically polymerizable compound (A) and the cationically polymerizable compound (B).

6. The composition for a fiber-reinforced composite material according to claim 1, wherein the radically polymerizable compound (A) is a compound having a cyclic structure.

7. The composition for a fiber-reinforced composite material according to claim 1, wherein the radically polymerizable compound (A) is a compound having a tricyclodecane skeleton.

8. The composition for a fiber-reinforced composite material according to claim 1, wherein the cationically polymerizable compound (B) is a compound having a cyclic structure.

9. The composition for a fiber-reinforced composite material according to claim 1, wherein the cationically polymerizable compound (B) is a compound having a tricyclodecane skeleton.

10. The composition for a fiber-reinforced composite material according to claim 1, wherein the pot life (a time until the viscosity becomes two times the initial viscosity) at 25° C. is not less than 14 days.

11. A prepreg, being formed by impregnating a composition for a fiber-reinforced composite material according to claim 1 into a reinforcing fiber (E).

12. The prepreg according to claim 11, wherein the fiber mass content rate (Wf) of the reinforcing fiber (E) is 50 to 90% by weight.

13. The prepreg according to claim 11, wherein the reinforcing fiber (E) is at least one selected from the group consisting of carbon fibers, glass fibers and aramid fibers.

14. A fiber-reinforced composite material, being obtained by curing a prepreg according to claim 11.

15. The composition for a fiber-reinforced composite material according to claim 2, wherein a proportion (weight ratio) [(A)/(B)] of the radically polymerizable compound (A) to the cationically polymerizable compound (B) is more than 0/100 and not more than 80/20.

16. The composition for a fiber-reinforced composite material according to claim 2, wherein the content of the radical polymerization initiator (C) is 0.01 to 10 parts by weight based on 100 parts by weight of the total amount of the radically polymerizable compound (A) and the cationically polymerizable compound (B).

17. The composition for a fiber-reinforced composite material according to claim 3, wherein the content of the radical polymerization initiator (C) is 0.01 to 10 parts by weight based on 100 parts by weight of the total amount of the radically polymerizable compound (A) and the cationically polymerizable compound (B).

18. The composition for a fiber-reinforced composite material according to claim 2, wherein the content of the acid generator (D) is 0.1 to 20 parts by weight based on 100 parts by weight of the total amount of the radically polymerizable compound (A) and the cationically polymerizable compound (B).

19. The composition for a fiber-reinforced composite material according to claim 3, wherein the content of the acid generator (D) is 0.1 to 20 parts by weight based on 100 parts by weight of the total amount of the radically polymerizable compound (A) and the cationically polymerizable compound (B).

20. The composition for a fiber-reinforced composite material according to claim 4, wherein the content of the acid generator (D) is 0.1 to 20 parts by weight based on 100 parts by weight of the total amount of the radically polymerizable compound (A) and the cationically polymerizable compound (B).
